(19) United States
(12) Patent Application Publication
(10) Pub. No.: US 2013/0304573 A1
(43) Pub. Date: Nov. 14, 2013

(54) SYSTEM FOR PROVIDING SERVICE REVIEWS

(71) Applicant: Michael Pinhas, Staten Island, NY (US)

(72) Inventor: Michael Pinhas, Staten Island, NY (US)

(21) Appl. No.: 13/733,483

(22) Filed: Jan. 3, 2013

Related U.S. Application Data
(60) Provisional application No. 61/646,335, filed on May 13, 2012.

(51) Int. Cl. G06Q 30/02

(52) U.S. Cl. CPC G06Q 30/0282
USPC 705/14.53; 705/347

(57) ABSTRACT

A method and system for a review company providing prompt verified customer-generated reviews for service businesses. A review company provides review-production assistance to the service business' customers and a publicly accessible web site for posting verified customer-generated reviews. The customer produces a customer-generated review, optionally including supplying the customer's email address. If the customer does not supply a valid email address, that customer's review is forwarded to the reviewed service business and is not verified. If the customer does supply a valid email address, the review company sends a verification email to that email address requesting a verification response. If no response is received by the review company within a predetermined time, customer's review not posted. If a verification response is received by the review company within a predetermined time, that customer's review is forwarded to the reviewed service business and is posted.

### RELATIONSHIP TO OTHER APPLICATIONS

This application claims the benefit of U.S. provisional patent application 61/646,335 filed May 13, 2012 to the same inventor.

### TECHNICAL FIELD

This invention relates to review company methods for providing customer-generated reviews of service providers, where the reviews are produced electronically at the place of service.

### BACKGROUND

Service businesses use customer reviews to improve the quality and value of their services. The Internet features web sites at which reviews of various service businesses are presented. One problem that has arisen with web site reviews is that unscrupulous persons give false bad reviews of a competitor's business in order to gain a market advantage. As a result, some review web sites are skewed negative. A second problem that arises is that the reviews are not provided promptly after service is rendered, so details may be forgotten, or opportunity to correct a problem in the business may be missed. Likewise, good reviews may not be promptly posted because of delay or procrastination by the customer.

Published US patent application 20010037244 to Mattson discloses a system and method for providing real-time restaurant reviews that uses an electronic device for entering consumer satisfaction survey data by the consumer at the place where services were received. Mattson does not disclose screening, verification of identity of the reviewer, nor a separate review company for verification of the identity of the reviewer.

Published US patent application 20060085267 to Lovegreen et al. discloses a multi- function customer satisfaction survey device in the form of an electronic tip tray that can be used by a consumer to input customer satisfaction survey data and transmit it wirelessly to a base unit in the restaurant. The data may include the customer's email address, which may be sent to a correspondence server for supporting an email advertising campaign, which may be run by a separate company. The survey results may be posted on a web site for managerial use.

Published US patent application 20070226063 to Hanson discloses as real-time subjective and demographic venue evaluation method that includes consumers adding review comments via either a web-based application or submitted from a mobile application.

Published US patent application 20090240566 to Lovegreen et al. discloses a method of managing customer information that includes electronically obtaining and storing the customer's responses in a memory of a portable electronic survey device, wirelessly transmitting the responses to a base unit, and analyzing the responses to derive management information. The information may be posted on a private web site for use by managers.

U.S. Pat. No. 6,167,435 to Druckenmiller et al. discloses a double opt-in method and system for verifying subscriptions to information distribution services that includes sending a potential subscriber a email with a token and requiring the potential subscriber to reply via email or URL, with the token, as a condition of subscription.

U.S. Pat. No. 6,233,564 to Schulze, Jr. discloses a system for merchandising using consumer information from surveys that includes offering an incentive, such as a coupon, for completing a user-initiated survey.

U.S. Pat. No. 7,720,705 to Stein discloses a system and method for real-time updating service provider ratings that includes a separate rating company that provides a web site where consumers can view consumer reviews.

Therefore, a need exists for a verified review system run by a review company that enables the production of a review promptly after the service is provided at the place in which the service is provided and a way to verify that the review is legitimate.

### OBJECTS AND FEATURES OF THE INVENTION

A primary object and feature of the present invention is to overcome the above-mentioned problems and fulfill the above-mentioned needs.

Another object and feature of the present invention is to provide for a system for operating a review company that involves providing prompt and verified customer-generated reviews.

It is a further object and feature of the present invention to provide discrimination between verified and unverified reviews.

It is a further object and feature of the present invention to provide a system that communicates all customer-generated reviews to the service business and only posts verified customer-generated reviews on a publicly available web site.

It is a further object and feature of the present invention to provide a system that provides customer-generated reviews generated at the place of business of the service company.

It is a further object and feature of the present invention to have the review company provide electronic assistive means for producing and collecting the customer-generated reviews.

It is an additional primary object and feature of the present invention to provide such a system that is efficient, inexpensive and handy. Other objects and features of this invention will become apparent with reference to the following descriptions.

### SUMMARY OF THE INVENTION

In accordance with a preferred embodiment hereof, this invention provides a system for providing prompt verified customer-generated reviews for service businesses. A review company provides electronic assistive means to the service business and provides a public accessible review-posting web site on which verified customer-generated reviews are posted. A customer of the service business is provided access to electronic review forms via the electronic assistive means. An electronic review form, accessed using the assistive electronic means, provides the customer an opportunity to produce a customer-generated review, including supplying the customer's email address. If the customer does not supply a valid email address, the remainder of that customer's review is forwarded to the reviewed service business and is not posted on the review-posting web site. If the customer does supply a valid email address, the review company sends an email at that address. The email requests a verification response. If no verification response is received by the review company within a predetermined amount of time, the remainder of that customer's review is forwarded to the reviewed service business and is not posted on the review-posting web site. If a verification response is received by the review company within a predetermined amount of time, that customer's review is forwarded to the reviewed service business and is posted on the review-posting web site. Optionally, a customer who provides a verification response may receive a coupon for products of the service business, preferably via the review company.

The present invention provides a business method for a review company providing service reviews, the review company business method including the combination of the steps of: a computer-implemented step of the review company providing a review-posting website on the Internet for publicly posting at least one customer-generated review; an at least partially computer-implemented step of the review company providing electronic assistive means to a service business for assisting a customer of the service business in producing a customer-generated review in a place of business of the service business; a computer-implemented step of the review company receiving the customer-generated review that was produced using the electronic assistive means; a computer-implemented step of the review company determining if the received customer-generated review includes a valid email address; if the received customer-generated review is determined by the review company to not include a valid email address, then the review company executing the computer-implemented steps of: the review company sending the received customer-generated review to the service business; and the review company ending the business method; if the received customer-generated review is determined by the review company to include a valid email address, then the review company executing the computer-implemented step of sending a verification email to the email address; a computer-implemented step of the review company determining if a response to the verification email has been received; if the response is determined by the review company to not have been received after a predetermined amount of time, then the review company executing the computer-implemented steps of: the review company sending the received review to the service business; and the review company ending the business method; and if the response is determined by the review company to have been received within a predetermined amount of time, then the review company executing the computer-implemented steps of: sending the received customer-generated review to the service business with notification that the received customer-generated review is verified; the review company posting the received customer-generated review on the review-posting website; and the review company ending the business method. The method, further including the computer-implemented step of the review company sending a coupon to the email address if the response is determined by the review company to have been received within the predetermined amount of time. The method, where the electronic assistive means includes a tablet computer preprogrammed to interactively assist a customer in production of a customer review. The method, where the tablet computer includes wireless communication for sending the customer-generated review to become the received customer review. The method, where the tablet computer includes a tablet computer owned by the service business and having a computer program to interactively assist a customer in production of a customer-generated review using a review-production website provided by the review company, where the review company provides a URL for the review-production website to the service business for use with the computer program. The method, where the step of the review company providing electronic assistive means includes a computer-implemented step of providing a native application to interactively assist the customer in production of a customer-generated review and to store the customer-generated review. The method, where the electronic assistive means includes wireless communication for sending the customer-generated review to become the received customer review. The method, where the step of the review company providing electronic assistive means includes a computer-implemented step of providing a review-production website on the Internet preprogrammed to interactively assist a customer in production of a review. The method, where the review-production website is accessible to the customer via one of a URL and a QR code provided at a place where services were rendered. The method, where the review-production website includes wireless communication for sending the customer-generated review to become the received customer-generated review. The method, where the computer-implemented step of determining if the received customer-generated review includes a valid email address takes place while the customer is at the service business' place of business. The method, where the computer-implemented step of determining if a response to the verification email has been received takes place while the customer is at the service business' place of business.

The present invention further provides a business method for a review company providing service reviews, the review company business method including the combination of the steps of: a computer-implemented step of the review company providing a website on the Internet for publicly posting at least one customer review; an at least partially computer-implemented step of the review company providing electronic assistive means to a service business for assisting a customer of the service business in producing a customer-generated review at a place of business of the service business; a computer-implemented step of the review company receiving the customer-generated review that was produced using the electronic assistive means by the customer at the service business' place of business; a computer-implemented step of the review company determining, while the customer is at the service business' place of business, if the received customer-generated review includes a valid email address; if the received customer-generated review is determined by the review company to not include a valid email address, then the review company executing the computer-implemented steps of: the review company sending the received customer-generated review to the service business; and the review company ending the business method; if the received customer-generated review is determined by the review company to include a valid email address, then the review company executing the computer-implemented step, while the customer is at the service business' place of business, of sending a verification email to the email address; a computer-implemented step of the review company determining if a response to the verification email has been received, while the customer is at the service business' place of business; if the response is determined by the review company to not have been received after a predetermined amount of time, then the review company executing the computer-implemented steps of: the review company sending the received review to the service business; and the review company ending the business method; and if the response is determined by the review company to have been received within a predetermined amount of time, then the review company executing the computer-implemented steps of: the review company sending the received customer-generated review to the service business with notification that the received customer-generated review is verified; the review company posting the received customer-generated review on the review-posting website; and the review company ending the business method. The method, further including the computer-implemented step of the review company sending a coupon to the email address if the response is determined to have been received within the predetermined amount of time. The method, where the electronic assistive means includes a tablet computer preprogrammed to interactively assist a customer in production of a review, where at least one of: the tablet computer includes wireless communication for sending the customer-generated review to become the received customer-generated review; and the tablet computer includes a tablet computer owned by the service business having a computer program to interactively assist a customer in production of a customer-generated review using a native application provided by the review company, where the native application is operable to store the customer-generated review for later transmission. The method, where the step of the review company providing electronic assistive means includes a computer-implemented step of providing a review-production website on the Internet preprogrammed to interactively assist a customer in production of a review, where at least one of: the review-production website is accessible to the customer via one of a URL and a QR code provided at a place where services were rendered; and the review-production website includes wireless communication for sending the customer-generated review to become the received customer review. The method, where: the electronic assistive means includes a native application on an electronic device that can be used by a customer to interactively assist the customer in production of a customer-generated review; and the electronic assistive means includes wireless communication for sending the customer-generated review to become the received customer-generated review.

The present invention yet further provides a business method for a review company providing service reviews, the method including the combination of the steps of: a computer-implemented step of the review company providing a review-posting website on the Internet for publicly posting at least one customer review; an at least partially computer-implemented step of the review company providing electronic assistive means to a service business for assisting a customer of the service business in producing a customer-generated review at a place of business of the service business; a computer-implemented step of the review company receiving the customer-generated review that was produced using the electronic assistive means by the customer at the service business' place of business; a computer-implemented step of the review company sending the received customer-generated review to the service business; a computer-implemented step of the review company determining, while the customer is at the service business' place of business, if the received customer-generated review includes a valid email address; if the received customer-generated review is determined by the review company to not include a valid email address, then the review company executing the computer-implemented steps of ending the business method; if the received customer-generated review is determined by the review company to include a valid email address, then the review company executing the computer-implemented step, while the customer is at the service business' place of business, of sending a verification email to the email address; a computer-implemented step of the review company determining if a response to the verification email has been received, while the customer is at the service business' place of business; if the response is determined by the review company to not have been received after a predetermined amount of time, then the review company executing the computer-implemented step of ending the business method; and if the response is determined by the review company to have been received within a predetermined amount of time, then the review company executing the computer-implemented steps of: the review company sending a notification to the service business that the received customer-generated review is verified; the review company posting the received customer-generated review on the review-posting website; and the review company ending the business method. The method, where the electronic assistive means includes a tablet computer preprogrammed to interactively assist a customer in production of a review, where at least one of: the tablet computer includes wireless communication for sending the customer-generated review to become the received customer-generated review; and the tablet computer includes a tablet computer owned by the service business and having a computer program to interactively assist a customer in production of a customer-generated review using a native application provided by the review company. The method, where the step of the review company providing electronic assistive means includes a computer-implemented step of providing a review-production native application preprogrammed in an electronic device to interactively assist a customer in production of a review, where at least one of: the review-production native application is accessible to the customer via the electronic device provided at a place where services were rendered; and the review-production native application includes wireless communication for sending the customer-generated review to become the received customer-generated review.

### BRIEF DESCRIPTION OF THE DRAWINGS

The present invention will hereinafter be described in conjunction with the following drawing figures, wherein like numerals denote like elements, and

FIG. 1 is a diagrammatic view illustrating an exemplary service review process, from a service customer's point of view;

FIG. 2 is a diagrammatic view illustrating an exemplary embodiment of a method of a system for providing verified customer-generated service reviews, according to a preferred embodiment of the present invention;

FIG. 3 is a diagrammatic view illustrating another embodiment of a method of a system for providing verified service customer-generated reviews, according to another preferred embodiment of the present invention;

FIG. 4 is a diagrammatic view illustrating an exemplary step of the exemplary methods of FIG. 2 and FIG. 3, according to a preferred embodiment of the present invention;

FIG. 5 is a diagrammatic view illustrating an exemplary additional option to the exemplary service review mehtod of FIG. 1, from a service customer's point of view;

FIG. 6 is a diagrammatic view illustrating an exemplary additional option to the exemplary method of a system for providing verified customer-generated service reviews of FIG. 2, according to a preferred embodiment of the present invention;

FIG. 7 is a diagrammatic view illustrating exemplary parties in an exemplary embodiment of the exemplary service review system and exemplary transfers between those parties, according to a preferred embodiment of the present invention;

FIG. 8 is a diagrammatic view illustrating a second exemplary method of a system for providing verified customer-generated service reviews, according to a preferred embodiment of the present invention;

FIG. 9 is a screen shot of a top portion of an exemplary review company web page for posting verified customer-generated service reviews, according to a preferred embodiment of the present invention; and

FIG. 10 is a screen shot of an exemplary additional portion of review company web page for posting verified customer-generated service reviews showing two actual verified reviews, according to a preferred embodiment of the present invention.

### DETAILED DESCRIPTION OF THE INVENTION

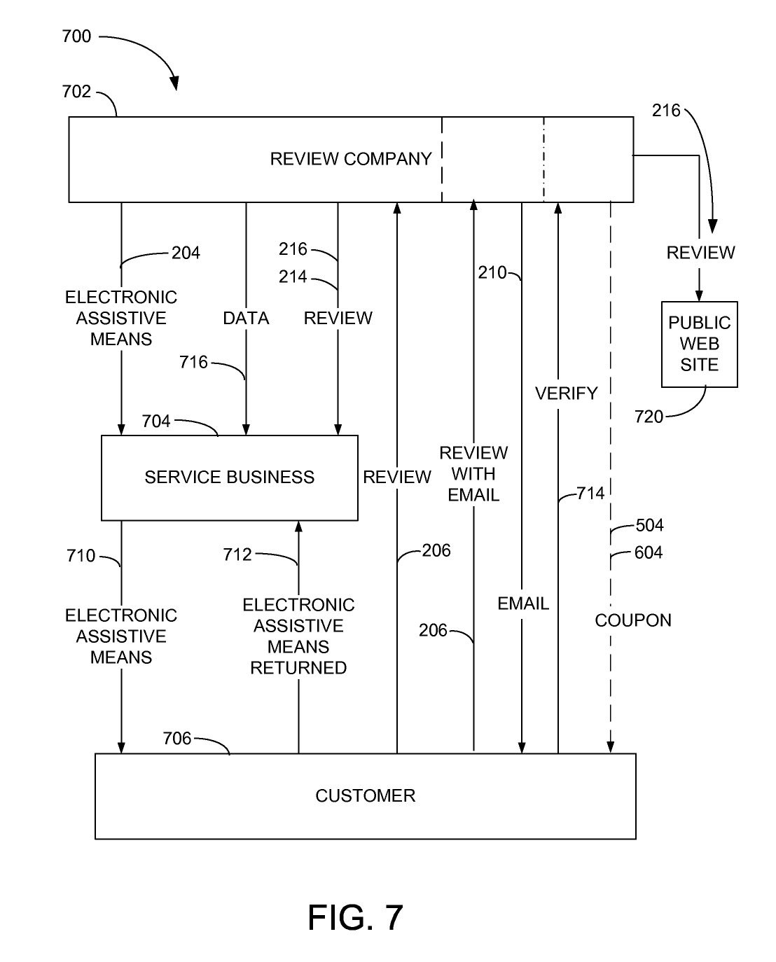

The term “review company” 702 as defined and used herein refers to a company that is in the business of collecting, processing, verifying, and displaying reviews of other businesses. It should be understood that the present invention involves three parties, the service business 704, which is to be reviewed; the service customer 706, who reviews the service business; and the review company 702, which collects, verifies, distributes and, optionally, posts the customer-generated reviews. See FIG. 7 for reference numbers for the three parties. The drawings and description implement the convention that the hundreds digit is the figure number in which the referenced item first appears.

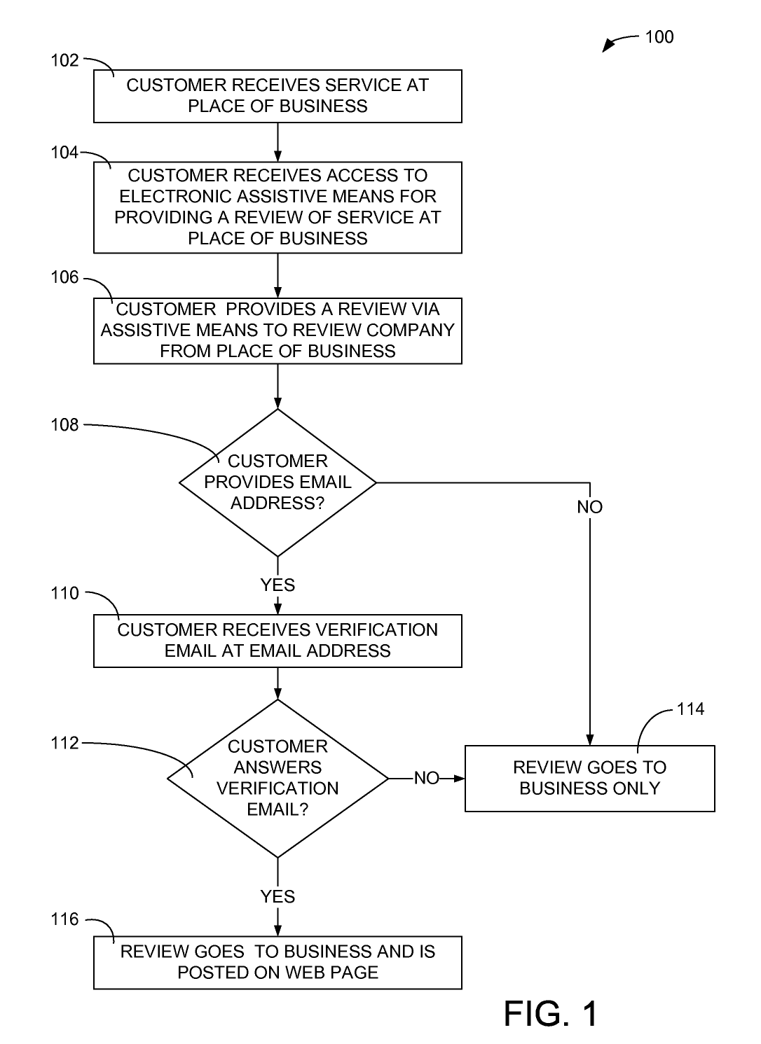

FIG. 1 is a diagrammatic view illustrating an exemplary embodiment of a customer-generated service review process 100, from a service customer's 706 point of view. In step 102, the customer 706 receives service from the service business 704 at the place of business of the service business 704. The service may be of any kind The place of business may be any retail, wholesale, professional services, or other place of service business. The exemplary embodiment described herein is focused on a restaurant business as the service business 704. However, the system is applicable to a wide variety of service businesses 704, even those that provide services outside normal retail establishments. For example, the system could be used for a road service company 704 that provides service to people with malfunctioning automobiles at the side of the road.

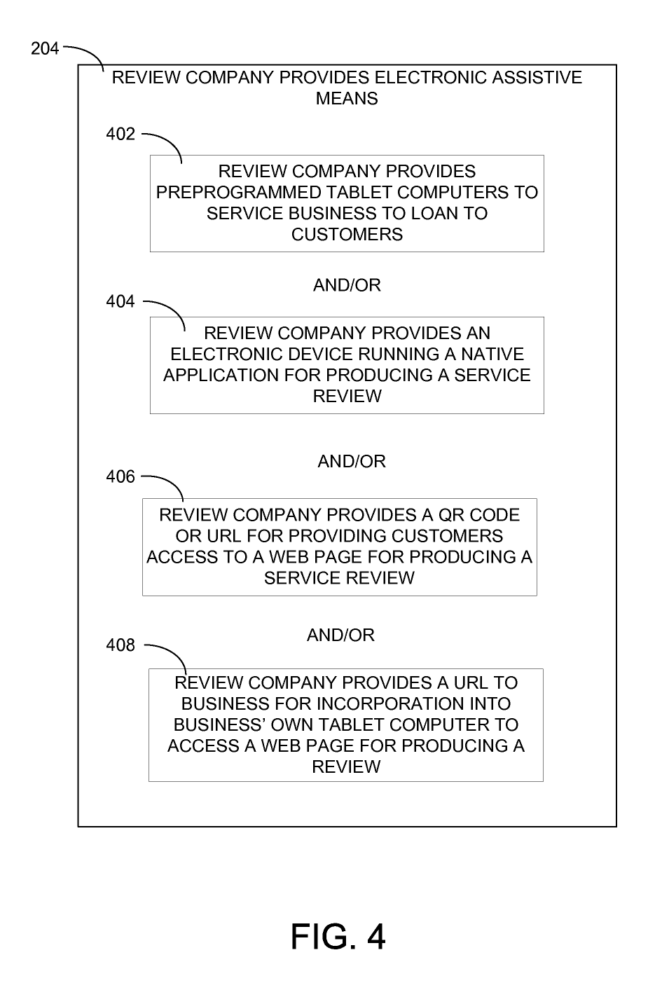

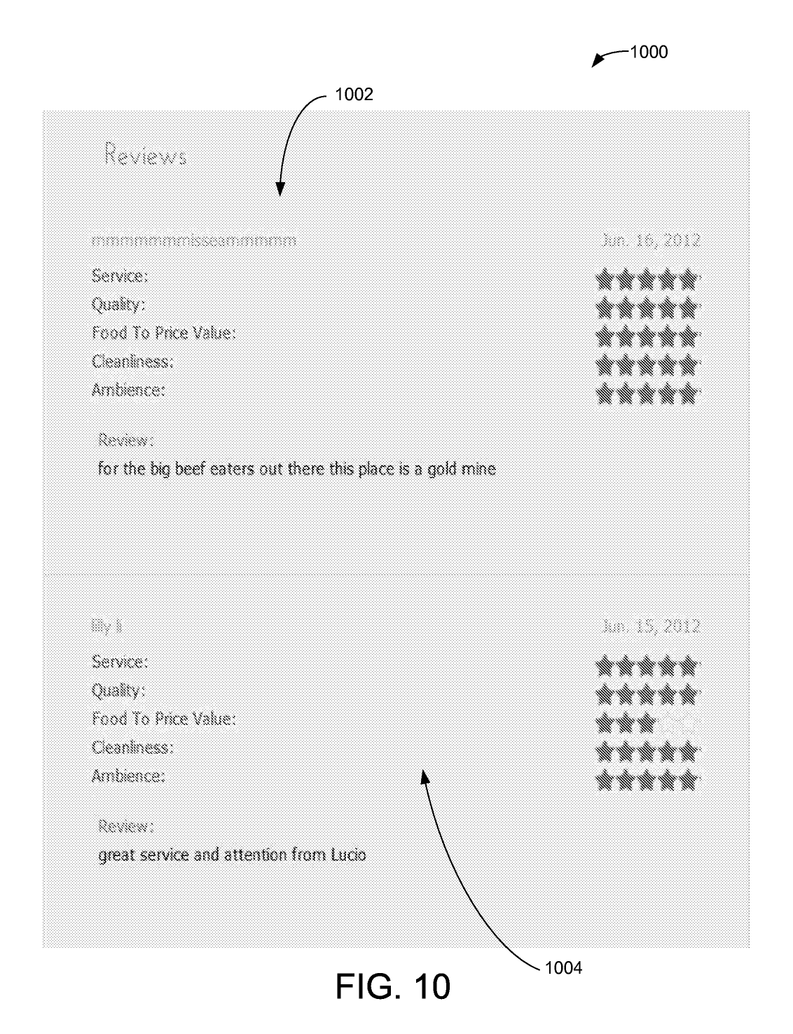

In step 104, at the completion of service, the service business 704 supplies the customer 706 with an electronic assistive means for producing a customer-generated review. One preferred electronic assistive means is a preprogrammed tablet computer (see FIG. 4, reference 402) that presents aspects of the service and asks for a rating for each particular aspect. For non-limiting example, an aspect of the service may be “promptness” and the rating may be checkboxes ranging from five to zero, with five being the best rating and zero being the worst. In a particular embodiment, stars may replace check boxes, with a highlight feature to highlight the number of stars that the reviewer regards as appropriate. An area for text entry is also provided for comments. The review company's 702 preprogrammed display looks similar to a customer-generated review 1002 or 1004 in FIG. 10, but with features to interactively assist the consumer 706, such as a highlight bar to drag at least partially over the stars and with a text window into which text may be typed by the customer 706. In addition, a place for the customer 706 to enter the customer's 706 email address is provided. The name of the service business 704 and, optionally, other identifying information for the service business 704 is programmed into the preprogrammed tablet computer. Electronic assistive means preferably include, or are in, or are accessed by, handheld electronic devices.

A second preferred electronic assistive means is a native application in an electronic device to enable the customer 706 to produce and optionally store a service customer-generated review (See FIG. 4, reference 404). In a preferred embodiment, the native application is downloaded and installed by the service business 706 for a fee from a review company's 704 web site. The native application provides functionality similar to that of the preprogrammed tablet computer. The review company's 702 native application display looks similar to a customer-generated review 1002 or 1004 in FIG. 10, but with features to interactively assist the consumer 706, such as a highlight bar to drag at least partially over the stars and with a text window into which text may be typed by the customer 706. In addition, a place for the customer 706 to enter the customer's 706 email address is provided. A particular service business 704 may use both the preprogrammed tablet computer and the native application for electronic assistive means.

A third preferred electronic assistive means is a QR code or URL for directly accessing a review-production web page that includes a fillable review form or similar interactive features that the customer 706 can use to produce a customer-generated review (See FIG. 4, reference 406). The review company's 702 review-production web page looks similar to a customer-generated review 1002 or 1004 in FIG. 10, but with features to interactively assist the consumer 706, such as a highlight bar to drag at least partially over the stars and with a text window into which text may be typed by the customer 706. In addition, a place for the customer 706 to enter the customer's 706 email address is provided. The URL or QR code provides access to a page customized and identified for the particular service business 704 and supplied by the review company 702. Any device for accessing the Internet can be used with this electronic assistive means. A particular service business 704 may use the preprogrammed tablet computer, and the native application, and/or the QR code or URL for direct access for electronic assistive means.

A fourth preferred electronic assistive means is to provide a URL to the service business 704 for incorporating into the service business' own tablet computers, or other equivalent internet access devices, to enable the service business' tablet computer to access a review-production web page (See FIG. 4, reference 408). The review company's 702 review-production web page looks similar to a customer-generated review 1002 or 1004 in FIG. 10, but with features to interactively assist the consumer 706, such as a highlight bar to drag at least partially over the stars and with a text window into which text may be typed by the customer 706. In addition, a place for the customer 706 to enter the customer's 706 email address is provided. The service business 704 provides the tablet computers to customers 706 while the customers 706 are producing customer-generated reviews. A particular service business 704 may use the preprogrammed tablet computer, and the native application, the QR code or URL for direct access, and/or a URL for the service business' tablet computers for electronic assistive means.

Those of skill in the art, enlightened by the present disclosure, will be aware of other devices, such as PDAs, laptop computers, etc., that may suffice for hosting a native application or preprogrammed customer-generated review software, or for accessing the internet, given a URL either directly or indirectly via a QR code. All such devices may used as part of, or used with, the electronic assistive means. Various platforms that can host interactive software and provide wireless communication may be used.

In step 106, the customer 706 produces a customer-generated review by interaction with the electronic assistive means. When the customer 706 is finished reviewing, pre-programmed software sends the customer-generated review, preferably by wireless means, to the review company 702. Once step 106 is complete, the customer-generated review will ultimately be sent to the reviewed service business 704, but some decisions 108, 122 may be made in the course of sending the customer-generated review to the service business 704. In a particular embodiment, wired communication may be used.

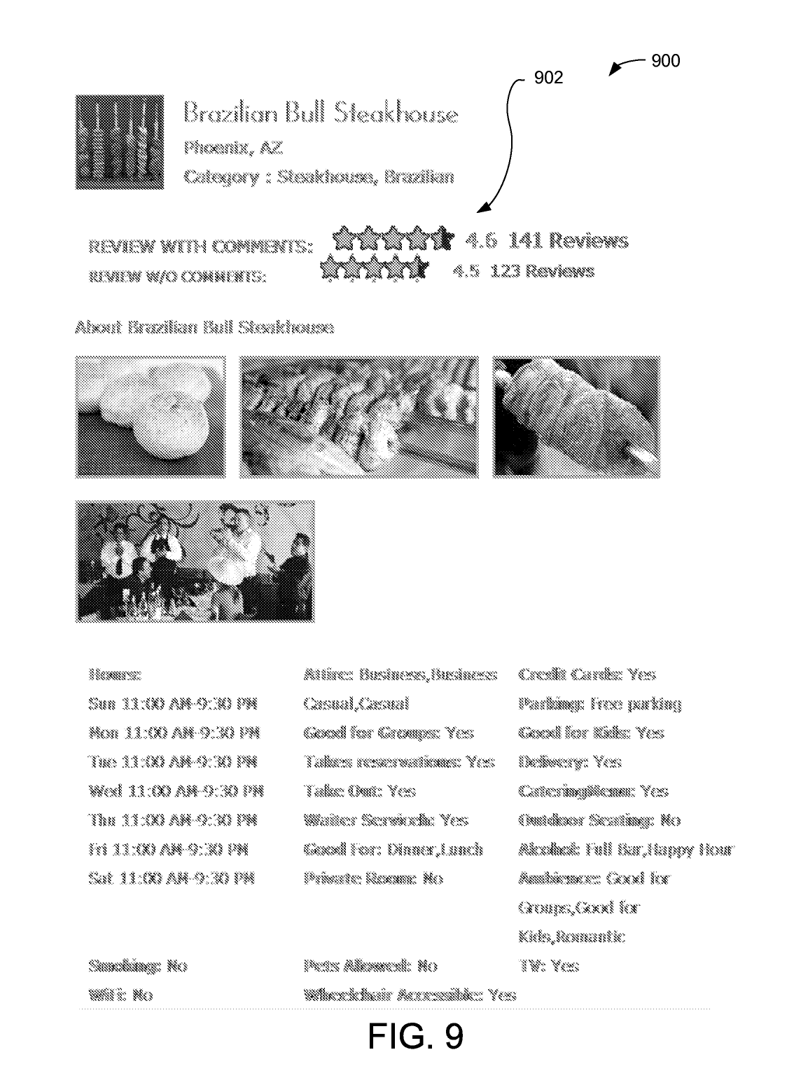

In step 108, a determination is made by the reviewing company 702 as to whether or not a valid email address has been provided. Once step 108 has been reached, the customer-generated review is destined to be sent to the service business 704. Provision of the email address by the customer 706 is optional, but customer-generated reviews without valid email addresses are not posted on the review-posting web site 900, 1000 (see FIGS. 9 and 10) of the review company 702. If no valid email address is found in step 108, the customer-generated review is transmitted to the service business 704 (step 114), and the process ends.

If a valid email address is found in step 108, the customer 706 receives an email containing a URL for validation in step 110. When the customer 706 clicks or otherwise selects the URL, the customer 706 thereby answers the verification email. If step 112 determines that the customer 706 did not answer the verification email within a predetermined amount of time, then the customer-generated review is sent only to the service business 704 (step 114) and the process ends. If step 112 determines that the customer 706 did answer the verification email within a predetermined amount of time, then the customer-generated review is both sent to the service business 704 and is posted on the review company's 702 publicly accessible review-posting web site 900, 1000 in step 116. A time limit may be imposed on the requirement to answer the verification email in order to ensure that the customer-generated review is timely. For non-limiting example, a ten minute time limit may be used. The publicly accessible web site 900, 1000 for posting the customer-generated reviews is read-only to the public.

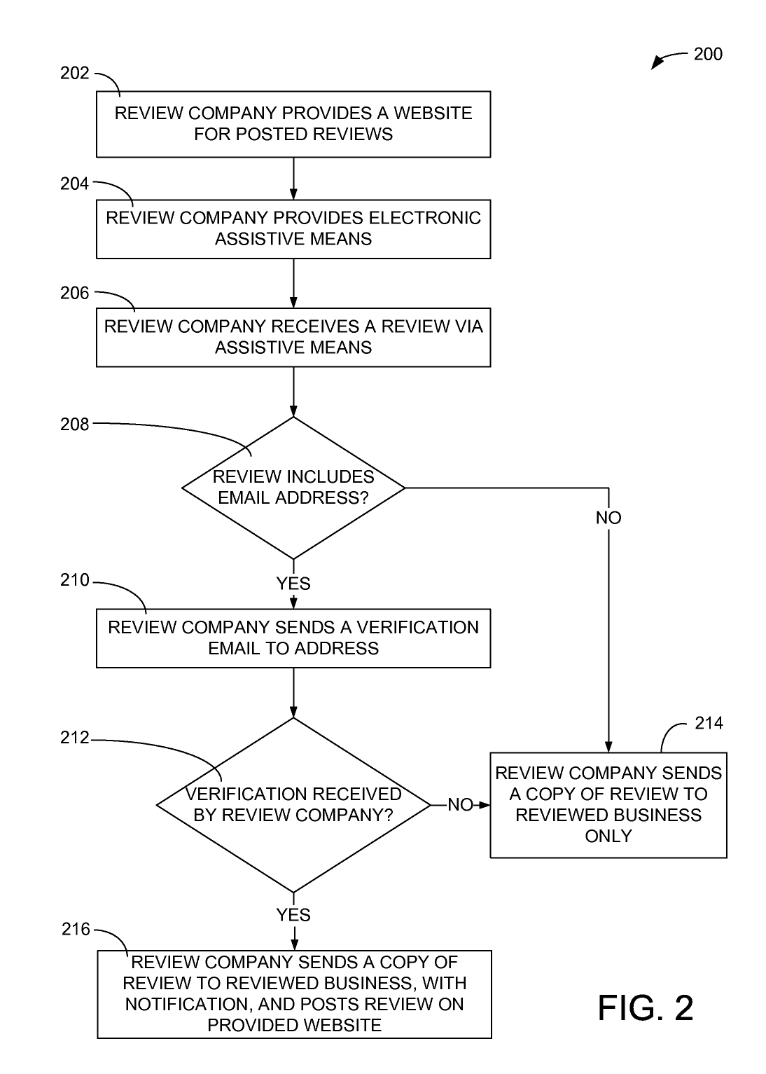

FIG. 2 is a diagrammatic view illustrating an exemplary embodiment of a method of system 200 for managing customer-generated service reviews, according to a preferred embodiment of the present invention. FIG. 2 presents the method of system 200 from the review company's 702 perspective, which is the perspective of the claims. System 200, like other embodiments discussed below, includes a method and implementation means for the method. In computer-implemented step 202, the review company 702 provides a publicly-available read-only review-posting web site 900, 1000 upon which customer-generated reviews may be posted. Of course, the review-posting web site 900, 1000 can be written upon by the review company 702: the review company 702 review-posting web site 900, 1000 is read-only to the public. The review-posting web site 900, 1000 preferably lists customer-generated reviews for a plurality of service businesses and the customer-generated reviews are organized by service business 704 name. In an alternate embodiment, customer-generated reviews may also be organized by reviewer, using a unique ID associated with the reviewer's email address.

In at least partially computer-implemented step 204, the review company 702 provides electronic assistive means to the service business 704 for the use of the customers 706 of the service business 704 at the place of business of the service business 704. One preferred electronic assistive means is a preprogrammed tablet computer (see FIG. 4, reference 402) that presents aspects of the service and asks for a rating for each particular aspect. The preprogramming is a partial computer-implemented step. The review company's 702 review-production web page looks similar to a customer-generated review 1002 or 1004 in FIG. 10, but with features to interactively assist the consumer 706, such as a highlight bar to drag at least partially over the stars and with a text window into which text may be typed by the customer 706. In addition, a place for the customer 706 to enter the customer's 706 email address is provided. For non-limiting example, an aspect of the service may be “service” and the rating may be checkboxes ranging from five to zero, with five being the best rating and zero being the worst. In a particular embodiment, stars may replace check boxes, with a highlight bar feature to highlight the number of stars that the reviewer regards as appropriate. An area for text entry is also provided for comments. See FIGS. 9 and 10. In addition, a place for the customer 706 to enter the customer's 706 email address is provided. The name of the service business 704 and, optionally, other identifying information and information useful to the service business 704 is programmed into the preprogrammed tablet computer.

A second preferred electronic assistive means is a native application in an electronic device to enable the customer 706 to produce and optionally store a customer-generated service review (See FIG. 4, reference 404). In a preferred embodiment, the native application is downloaded and installed for fee from a review company's 704 web site, as a computer-implemented step. The native application provides functionality similar to that of the preprogrammed tablet computer. The review company's 702 native application display looks similar to a customer-generated review 1002 or 1004 in FIG. 10, but with features to interactively assist the consumer 706, such as a highlight bar to drag at least partially over the stars and with a text window into which text may be typed by the customer 706. In addition, a place for the customer 706 to enter the customer's 706 email address is provided. A particular service business 704 may use both the preprogrammed tablet computer and the native application for electronic assistive means.

A third preferred electronic assistive means is a QR code or URL provided by the review company 702 for directly accessing a review-production web page that includes a fillable review form or similar interactive features that assist the customer 706 to produce a customer-generated review (See FIG. 4, reference 406). The URL or QR code provides computer-implemented access to a page customized and identified for the particular service business 704 and supplied by the review company 702. Any device for accessing the Internet can be used with this electronic assistive means. The review company's 702 review-production web page looks similar to a customer-generated review 1002 or 1004 in FIG. 10, but with features to interactively assist the consumer 706, such as a highlight bar to drag at least partially over the stars and with a text window into which text may be typed by the customer 706. In addition, a place for the customer 706 to enter the customer's 706 email address is provided. A particular service business 704 may use the preprogrammed tablet computer, and the native application, and/or the QR code or URL for direct access for electronic assistive means.

A fourth preferred electronic assistive means is to provide a URL to the service business 704 for incorporating into the service business' 704 own tablet computers, or other internet access devices, to enable the service business' 704 tablet computer to access a review-production web page (See FIG. 4, reference 408) as the computer-implemented step. The service business 704 provides the tablet computers to customer 706s while they are producing customer-generated reviews. The review company's 702 review-production web page looks similar to a customer-generated review 1002 or 1004 in FIG. 10, but with features to interactively assist the consumer 706, such as a highlight bar to drag at least partially over the stars and with a text window into which text may be typed by the customer 706. In addition, a place for the customer 706 to enter the customer's 706 email address is provided. A particular service business 704 may use the preprogrammed tablet computer, and the native application, the QR code or URL for direct access, and/or a URL for the service business' tablet computers for electronic assistive means.

Those of skill in the art, enlightened by the present disclosure, will be aware of other devices, such as PDAs, laptop computers, etc., that may suffice for hosting a native application or preprogrammed customer-generated review software. Various platforms that can host interactive software and provide wireless communication may be used.

In computer-implemented step 206, the review company 702 receives a customer-generated review produced by a customer 706 while using the electronic assistive means. The customer-generated review is stored electronically by the review company 702. In step 208, the review company 702 determines if the customer-generated review includes a customer's 706 email address. If not, the review company 702 supplies a copy of the customer-generated review only to the service business 704 in computer-implemented step 214, and the process ends. Once computer-implemented step 206 is completed, it is certain that the customer-generated review will be provided to the service business, but a few decisions 208 and 212, may be made first.

If computer-implemented step 208 determines that the received customer-generated review includes a valid email address, then the review company 702 sends 210, via computer, a verification email to the customer's 706 valid email address. In a preferred embodiment, the verification email contains a URL. When the customer 706 clicks or otherwise selects the URL, the customer 706 thereby answers the verification email. In another preferred embodiment, the customer 706 responds to the verification email by using the “reply” feature of his email application. If computer-implemented step 212 determines that the customer 706 did not answer the verification email within a predetermined amount of time, then the customer-generated review is sent only to the service business 704 (step 214) and the process ends. If computer-implemented step 212 determines that the customer 706 did answer the verification email within a predetermined amount of time, then the customer-generated review is sent to the service business 704 and is posted on the review company's 702 publicly accessible review-posting web site in computer-implemented step 216. A notification that a review has been verified is also sent to the service business 704 in step 216. In a particular embodiment, the posting 216 of the verified review may operate as the notification. A time limit may be imposed on the requirement to answer the verification email in order to ensure that the customer-generated review is generated at the place of service business 704. The review company's 702 publicly accessible web site 900, 1000 for posting customer-generated reviews is read-only to the public.

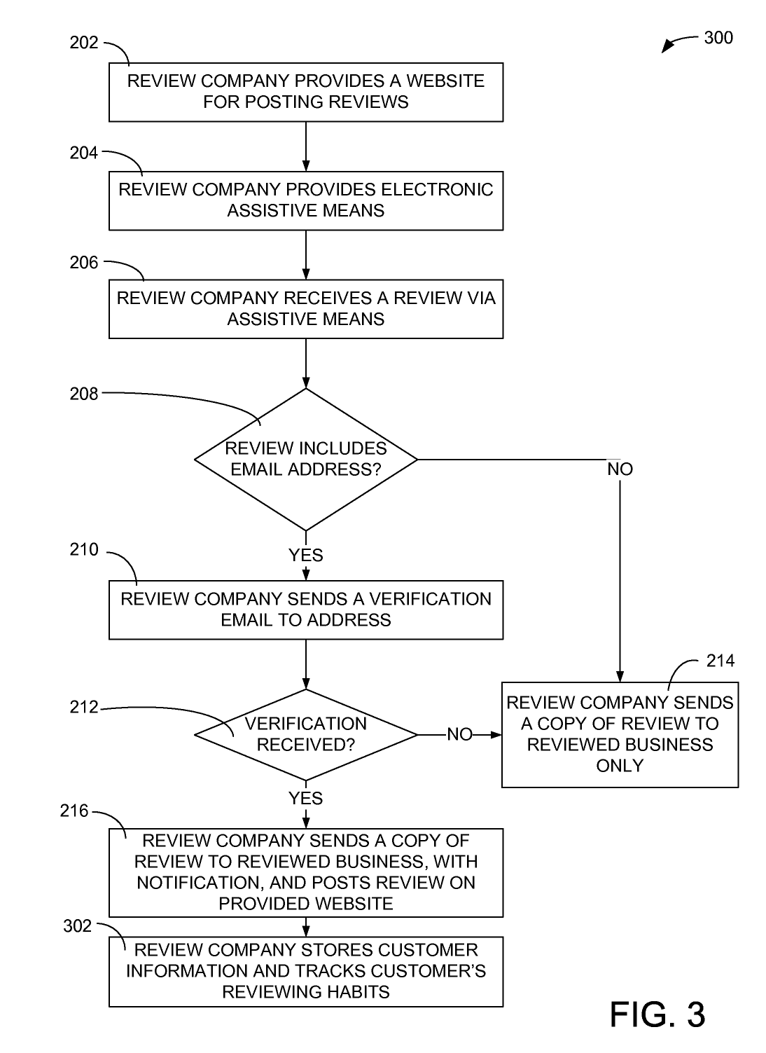

FIG. 3 is a diagrammatic view illustrating another exemplary embodiment of a method of a system 300 for providing service customer-generated reviews, according to another preferred embodiment of the present invention. System 300 is identical to system 200 except for final computer-implemented step 302. In step 302, the reviewing company stores customer 706 information and tracks the reviewing habits of the customer 706. This tracking serves multiple purposes. First, it assists in identifying chronically negative reviewers. Second, persons wishing to become professional reviewers can attract a following in the alternate embodiment in which customer-generated reviews are displayed by the reviewer. Third, reviewers who generally give good customer-generated reviews but occasionally give bad ones provide information about what is important to the reviewer, and so service businesses getting bad customer-generated reviews from such reviewers can be advised on improvements they might make. Preferably, steps from 206 to 216 occur while the customer 706 is at the place of service business 704.

FIG. 4 is a diagrammatic view illustrating an exemplary computer-implemented step 204 of the methods of systems 200 and 300 of FIG. 2 and FIG. 3, according to a preferred embodiment of the present invention. Computer-implemented step 204 may include one or more of steps 402, 404, 406, and 408. In at least partially computer-implemented step 402, a preprogrammed tablet computer is provided by the reviewing company to the service business 704 for loaning to customers 706 for producing customer-generated reviews at the place of business of the service business 704. In computer-implemented step 404, the review company 702 provides a native application that the customer 706 can use for free. In computer-implemented step 406, the review company 702 provides a QR code or a URL to the service business 704 to provide to customers 706 to enable them to access a review-production web page (also provided by the reviewing company) to produce customer-generated reviews. In computer-implemented step 408, the review company 702 provides a review-production web site URL to the business to use in the service business' own tablet computers, or the like. These options are not exhaustive, as discussed above.

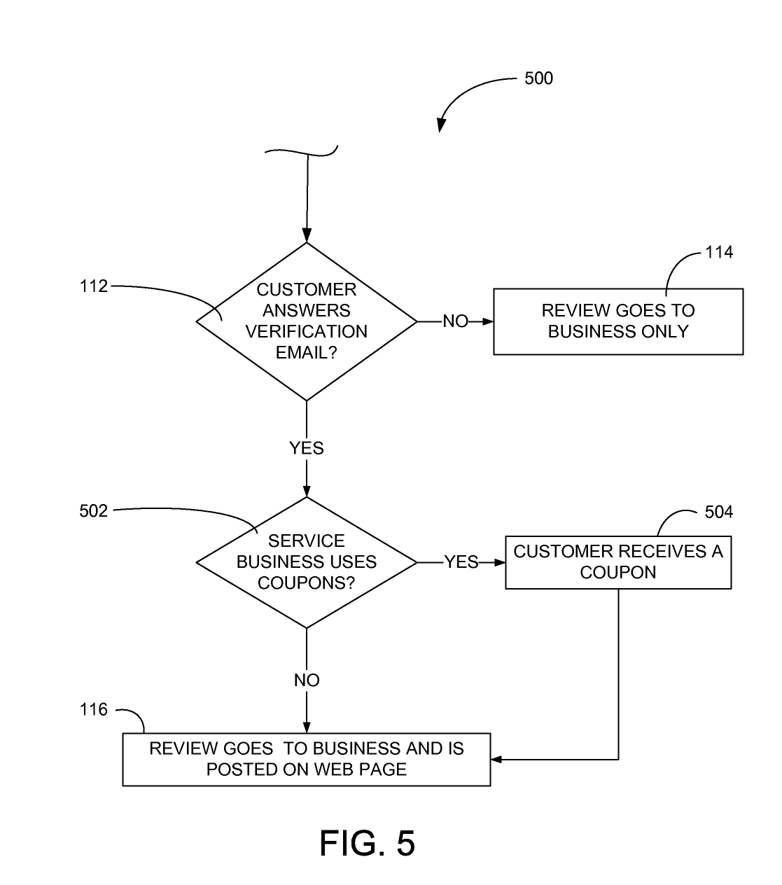

FIG. 5 is a diagrammatic view illustrating an exemplary additional option 500 to the exemplary service review process 100 of FIG. 1, from a service customer's 706 point of view. After the customer 706 answers the verification email within a predetermined amount of time in step 112, the review company 702 software determines 502 if the service company 704 that was reviewed is one that sends coupons. If so, the customer 706 receives a coupon by email 504 and the customer-generated review goes to the service business 704 and is posted on the review company's 702 publicly accessible web site 900, 1000 in step 116. Else, the computer-implemented coupon step 504 is skipped.

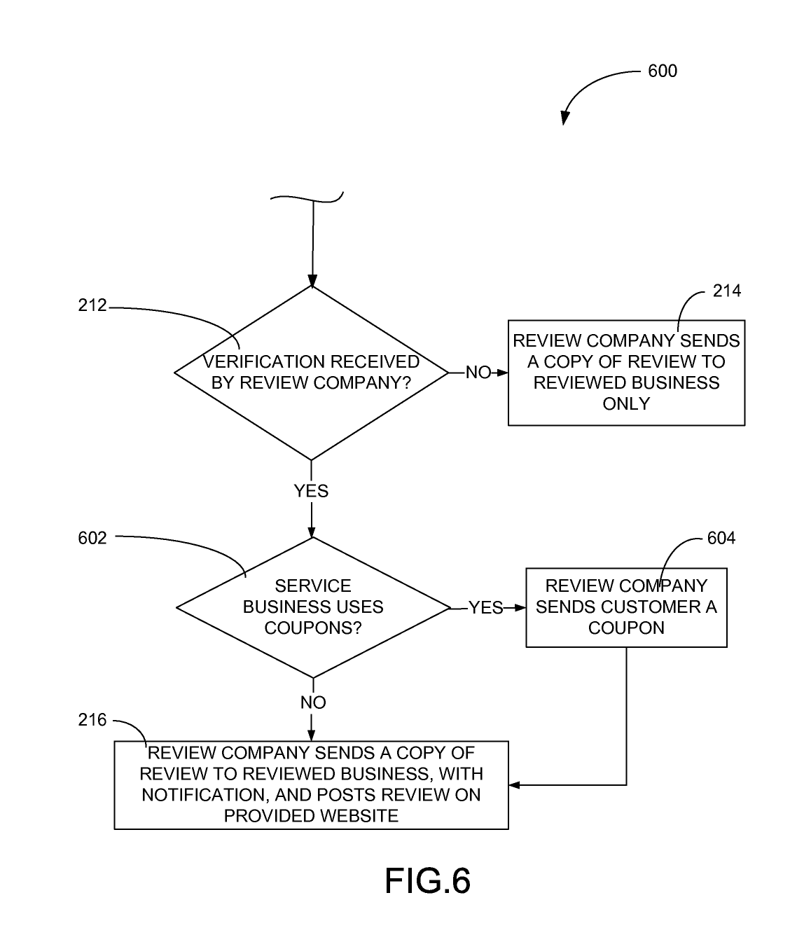

FIG. 6 is a diagrammatic view illustrating an exemplary additional option 600 to the exemplary method of a system 200 for providing customer-generated service review of FIG. 2, according to a preferred embodiment of the present invention. If computer-implemented step 212 determines that the review company 702 has received a verification email within a predetermined amount of time, then computer-implemented step 602 determines if the reviewed service business 704 sends coupons to customers 706 who verify their email addresses. If so, the review company 702 preferably sends 604 the coupon to the customer 706. In a particular, still preferable, embodiment, the review company 702 communicates to the service business 704 that the customer 706 should be sent 604 a coupon, and the service business 704 sends 604 the coupon directly to the customer 706. If computer-implemented step 602 determines that the reviewed service business 704 does not send 604 coupons, then computer-implemented step 216 is executed. In an alternate embodiment, steps 602 and 604 may be taken after step 216 instead of immediately after step 212.

FIG. 7 is a diagrammatic view illustrating exemplary parties 702, 704, and 706 in an exemplary embodiment 700 of the exemplary service review system 200 and exemplary transfers 204, 206, 210, 214, 216, 504, 604, 710 and 712 between the exemplary parties 702, 704, and 706, according to a preferred embodiment of the present invention. Review company 702 provides 204 electronic assistive means to service business 704 which, in turn, provides 710 the electronic assistive means to customer 706. The customer may return 712 the electronic means depending, at least in part, on whether or not the electronic assistive means include a device. Preferably, the review company 702 receives 206 a customer-generated review from the customer 706 which customer-generated review may be include the customer's 706 email address. If 208 the review company 702 receives 206, within a predetermined amount of time, a customer-generated review with an email address in it, then the review company 702 sends an email 210 to the customer 706 requesting verification from the customer 706. If 212 the review company 702 receives verification 714 within a predetermined amount of time, then the review company 702 posts 216 the verified customer-generated review on the review company's 702 publicly accessible review-posting web site 900 (see FIG. 9). Depending on the preferences of the service business 704 and other optional factors, the review company 702 may send coupons 504 and 604 to customer 706. All customer-generated reviews that the review company 702 receives 206 are sent 214, 216 to the service business 704. In addition, the review company 702 may send other data 716 to the service business 704 such as, for non-limiting examples, trend data from analysis of customer-generated reviews and notifications of reviews being verified.

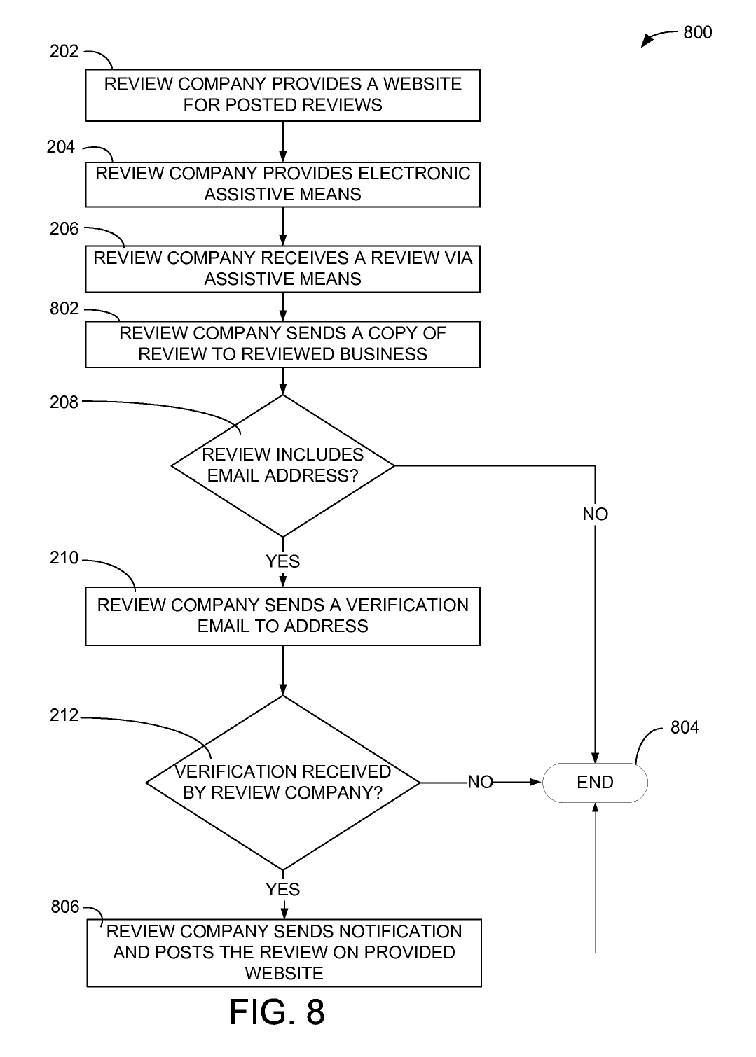

FIG. 8 is a diagrammatic view illustrating a second exemplary method of a system 800 for providing verified customer-generated service reviews, according to a preferred embodiment of the present invention. Second exemplary system 800 is a variation on exemplary system 200, in which customer-generated reviews received 206 by the review company 702 are immediately sent 802 to the service business 704. If email verification 208, 210, and 212 is accomplished within a predetermined amount of time, the review company 702 posts the customer-generated review on the provided review-posting web site 900 (see FIG. 9) and notifies service business 704 in computer-implemented step 806. All paths in the process have a common end 804.

FIG. 9 is a screen shot of a top portion 900 of an exemplary embodiment of a review company web page for posting verified customer-generated service reviews, according to a preferred embodiment of the present invention. The top portion 900 provides information about the service business 704 to the consumer 706, including an overall rating 902. Those of skill in the art, enlightened by the disclosure of the present invention, will be aware of the vast variety of web page layouts and content selections that are possible for implementing the present inventive purpose, all of which may be used within the scope of the present invention.

FIG. 10 is a screen shot of an exemplary embodiment of an additional portion 1000 of review company 702 web page for posting exemplary verified customer-generated service reviews showing two exemplary verified posted customer-generated reviews 1002 and 1004, according to a preferred embodiment of the present invention. The exemplary verified posted customer-generated reviews 1002 and 1004 include five evaluation areas, each rated on a five-star scale, as well as a text review window. The format of the exemplary verified posted customer-generated reviews 1002 and 1004 is exemplary of the display for the native application, preprogrammed tablet computer, and review-production web page, where the customer 706 may drag a highlighting bar over the stars, or portions thereof, in each category, and may type text into the text box. In addition, a place for entering the customer's 706 email address is provided in the display for the native application, preprogrammed tablet computer, and review-production web page. Those of skill in the art, enlightened by the disclosure of the present invention, will be aware of the vast variety of customer satisfaction surveys and rating schemes that are possible for implementing the present inventive purpose, all of which may be used within the scope of the present invention.

Preferably, in embodiments 200, 300, 600, and 800, steps from 206 to 216 or 806 occur while the customer 706 is at the place of service business 704.

Although applicant has described applicant's preferred embodiments of this invention, it will be understood that the broadest scope of this invention includes such modifications as variations in the electronic platforms used by the customers 706. The scope of the invention includes alternate embodiments where the functions of the reviewing company 702 are performed by the service business 704 and vice versa. Such scope is limited only by the above specification and the claims below. Further, many other advantages of applicant's invention will be apparent to those skilled in the art from the above descriptions.

1. A business method for a review company providing service reviews, the review company business method comprising the combination of the steps of:
a. a computer-implemented step of said review company providing a review-posting website on the Internet for publicly posting at least one customer-generated review;
b. an at least partially computer-implemented step of said review company providing electronic assistive means to a service business for assisting a customer of said service business in producing a customer-generated review in a place of business of said service business;
c. a computer-implemented step of said review company receiving said customer-generated review that was produced using said electronic assistive means;
d. a computer-implemented step of said review company determining if said received customer-generated review includes a valid email address;
e. if said received customer-generated review is determined by said review company to not include a valid email address, then said review company executing the computer-implemented steps of:
i. said review company sending said received customer-generated review to said service business; and
ii. said review company ending said business method;
f. if said received customer-generated review is determined by said review company to include a valid email address, then said review company executing the computer-implemented step of sending a verification email to said email address;
g. a computer-implemented step of said review company determining if a response to said verification email has been received;
h. if said response is determined by said review company to not have been received after a predetermined amount of time, then said review company executing the computer-implemented steps of:
i. said review company sending said received review to said service business; and
ii. said review company ending said business method; and
i. if said response is determined by said review company to have been received within a predetermined amount of time, then said review company executing the computer-implemented steps of:
i. sending said received customer-generated review to said service business with notification that said received customer-generated review is verified;
ii. said review company posting said received customer-generated review on said review-posting website; and
iii. said review company ending said business method.

2. The method of claim 1, further comprising the computer-implemented step of said review company sending a coupon to said email address if said response is determined by said review company to have been received within said predetermined amount of time.

3. The method of claim 1, wherein said electronic assistive means comprises a tablet computer preprogrammed to interactively assist such customer in production of said customer review.

4. The method of claim 3, wherein said tablet computer comprises wireless communication for sending said customer-generated review to become said received customer-generated review.

5. The method of claim 3, wherein said tablet computer comprises a tablet computer owned by said service business having a computer program to interactively assist such customer in production of said customer-generated review using a review-production website provided by said review company, wherein said review company provides a URL for said review-production website to said service business for use with said computer program.

6. The method of claim 3, wherein said step of said review company providing electronic assistive means comprises a computer-implemented step of providing a native application to interactively assist such customer in production of said customer-generated review and to store said customer review.

7. The method of claim 6, wherein said electronic assistive means comprises wireless communication for sending said customer-generated review to become said received customer-generated review.

8. The method of claim 1, wherein said step of said review company providing electronic assistive means comprises a computer-implemented step of providing a review-production website on the Internet preprogrammed to interactively assist such customer in production of said customer-generated review.

9. The method of claim 8, wherein said review-production website is accessible to such customer via one of a URL and a QR code provided at a place where services were rendered.

10. The method of claim 8, wherein said review-production website comprises wireless communication for sending said customer-generated review to become said received customer-generated review.

11. The method of claim 1, wherein said computer-implemented step of determining if said received customer-generated review includes a valid email address takes place while such customer is at said service business' place of business.

12. The method of claim 1, wherein said computer-implemented step of determining if a response to said verification email has been received takes place while such customer is at said service business' place of business.

13. A business method for a review company providing service reviews, the review company business method comprising the combination of the steps of:
a. a computer-implemented step of said review company providing a website on the Internet for publicly posting at least one customer-generated review;
b. an at least partially computer-implemented step of said review company providing electronic assistive means to a service business for assisting at least one customer of said service business in producing said at least one customer-generated review at a place of business of said service business;
c. a computer-implemented step of said review company receiving said at least one customer-generated review that was produced using said electronic assistive means by such customer at said service business' place of business;
d. a computer-implemented step of said review company determining, while such at least one customer is at said service business' place of business, if said received at least one customer-generated review includes a valid email address;
e. if said received at least one customer-generated review is determined by said review company to not include a valid email address, then said review company executing the computer-implemented steps of:
i. said review company sending said received at least one customer-generated review to said service business; and
ii. said review company ending said business method;
f. if said received at least one customer-generated review is determined by said review company to include a valid email address, then said review company executing the computer-implemented step, while said at least one customer is at said service business' place of business, of sending a verification email to said email address;
g. a computer-implemented step of said review company determining if a response to said verification email has been received, while said at least one customer is at said service business' place of business;
h. if said response is determined by said review company to not have been received after a predetermined amount of time, then said review company executing the computer-implemented steps of:
i. said review company sending said received at least one customer-generated review to said service business; and
ii. said review company ending said business method; and
i. if said response is determined by said review company to have been received within a predetermined amount of time, then said review company executing the computer-implemented steps of:
i. said review company sending said received at least one customer-generated review to said service business with notification that said received at least one customer-generated review is verified;
ii. said review company posting said received at least one customer-generated review on said review-posting website; and
iii. said review company ending said business method.

14. The method of claim 13, further comprising the computer-implemented step of said review company sending a coupon to said email address if said response is determined to have been received within said predetermined amount of time.

15. The method of claim 13, wherein said electronic assistive means comprises a tablet computer preprogrammed to interactively assist such at least one customer in production of said review, wherein at least one of:
a. said tablet computer comprises wireless communication for sending said at least one customer-generated review to become said received at least one customer review; and
b. said tablet computer comprises a tablet computer owned by said service business having a computer program to interactively assist such at least one customer in production of said at least one customer-generated review using a native application provided by said review company, wherein said native application is operable to store said at least one customer-generated review for later transmission.

16. The method of claim 13, wherein said step of said review company providing electronic assistive means comprises a computer-implemented step of providing a review-production website on the Internet preprogrammed to interactively assist such at least one customer in production of said review, wherein at least one of:
a. said review-production website is accessible to such at least one customer via one of a URL and a QR code provided at a place where services were rendered; and
b. said review-production website comprises wireless communication for sending said at least one customer-generated review to become said received at least one customer review.

17. The method of claim 13, wherein:
a. said electronic assistive means comprises a native application on an electronic device that can be used by such at least one customer to interactively assist such at least one customer in production of at least one customer review; and
b. said electronic assistive means comprises wireless communication for sending said at least one customer-generated review to become said received at least one customer review.

18. A business method for a review company providing service reviews, the method comprising the combination of the steps of:
a. a computer-implemented step of said review company providing a website on the Internet for publicly posting at least one customer review;
b. an at least partially computer-implemented step of said review company providing electronic assistive means to a service business for assisting at least one customer of said service business in producing at least one customer-generated review at a place of business of said service business;
c. a computer-implemented step of said review company receiving said at least one customer-generated review that was produced using said electronic assistive means by such at least one customer at said service business' place of business;
d. a computer-implemented step of said review company sending said received at least one customer-generated review to said service business;
e. a computer-implemented step of said review company determining, while such at least one customer is at said service business' place of business, if said received at least one customer-generated review includes a valid email address;
f. if said received at least one customer-generated review is determined by said review company to not include a valid email address, then said review company executing the computer-implemented steps of ending said business method;
g. if said received at least one customer-generated review is determined by said review company to include a valid email address, then said review company executing the computer-implemented step, while such at least one customer is at said service business' place of business, of sending a verification email to said email address;
h. a computer-implemented step of said review company determining if a response to said verification email has been received while such at least one customer is at said service business' place of business;
i. if said response is determined by said review company to not have been received after a predetermined amount of time, then said review company executing the computer-implemented step of ending said business method; and
j. if said response is determined by said review company to have been received within a predetermined amount of time, then said review company executing the computer-implemented steps of:
i. said review company sending a notification to said service business that said received at least one customer-generated review is verified;
ii. said review company posting said received at least one customer-generated review on said review-posting website; and
iii. said review company ending said business method.

19. The method of claim 18, wherein said electronic assistive means comprises a tablet computer preprogrammed to interactively assist such at least one customer in production of said at least one customer-generated review, wherein at least one of:
a. said tablet computer comprises wireless communication for sending said at least one customer-generated review to become said received at least one customer review; and
b. said tablet computer comprises a tablet computer owned by said service business having a computer program to interactively assist such at least one customer in production of at least one customer-generated review using a native application provided by said review company.

20. The method of claim 18, wherein said step of said review company providing electronic assistive means comprises a computer-implemented step of providing a review-production native application preprogrammed in an electronic device to interactively assist such at least one customer in production of at least one customer-generated review, wherein at least one of:
a. said review-production native application is accessible to such at least one customer via said electronic device provided at a place where services were rendered; and
b. said review-production native application comprises wireless communication for sending said at least one customer-generated review to become said received at least one customer review.
